(19) United States
(12) Patent Application Publication
(10) Pub. No.: US 2005/0270779 A1
(43) Pub. Date: Dec. 8, 2005

(54) Light projection rotary control indicator

(76) Inventor: James Mazur, Ft. Lauderdale, FL (US)

Correspondence Address: PITNEY HARDIN LLP, 7 TIMES SQUARE, NEW YORK, NY, 10036-7311, US

(21) Appl. No.: 10/862,941

(22) Filed: Jun. 8, 2004

(51) Int. Cl. G01D 11/28

(52) U.S. Cl. 362/253

(57) ABSTRACT

A rotary control indicator includes a knob with a reflective interior. The knob rotates in concert with a clear shaft which receives light from an LED. The knob further includes a radial notch. Light is reflected by the reflective interior to illuminate the control panel around a periphery of the knob. Further, light is projected out the radial notch to indicate the knob position.

### BACKGROUND OF THE INVENTION

1. Field of the Invention

This invention pertains to a rotary control indicator, such as a knob for an electronic music apparatus, such as a disk jockey mixer. A light source is emitted through the shaft of the knob so that the light is reflected from the interior of the knob toward the control panel. As there is clearance between the knob and the control panel, the illumination of the control panel is visible to the user of the apparatus. Further, there is a notch in the knob so that some light is reflected radially outward from the knob toward the control panel, to serve as an indicator of knob position.

2. Description of the Prior Art

In the prior art, it has been problematic to illuminate the controls on disk jockey mixers and other similar equipment in a dark night club, dance club, or similar establishment, for use by a disk jockey. Moreover, as disk jockeys are considered to be performers, it is desirable for the equipment to have visual excitement and appeal.

One typical solution is to provide a small gooseneck lamp to project light over the DJ mixer. However, this light is often a distraction and makes it difficult for the disk jockey to see into the darkened room, which is essential for him to coordinate his performance with the mood and activities of the crowd. Another typical solution is to light the edge of the knobs with an internal LED. While this solves the problem of seeing into the darkened room, it does not adequately address the problem of allowing the disk jockey to see the markings or indicators on the mixer.

### OBJECTS AND SUMMARY OF THE INVENTION

It is therefore an object of the present invention to provide a knob, or rotary control indicator, which allows a user to determine the knob position of a disk jockey mixer or similar piece of equipment in the dark.

It is therefore a further object of the present invention to provide a knob, or rotary control indicator, which allows a user to read the immediately surrounding areas of the control panel of a disk jockey mixer or similar piece of equipment in the dark.

It is therefore a still further object of the present invention to provide a knob, or rotary control indicator, which provides an aesthetically pleasing and exciting appearance for the control panel of a disk jockey mixer or similar piece of equipment.

These and other objects are attained by providing a rotary control indicator, which includes a knob which is rotatable upon a clear shaft potentiometer. An LED is mounted underneath the clear shaft potentiometer so that light is projected from the LED, through the clear shaft and into the interior of the knob. The knob has a reflective interior so that the light is projected toward the bottom of the knob. The bottom of the knob is open, and some clearance is provided between the knob and the control panel. Therefore, a beam of light is projected toward the control panel around the entire periphery of the knob and is visible to the user. Additionally, a notch is provided within the knob so that a beam of light is projected radially from the knob to illuminate and indicate the knob position

### DESCRIPTION OF THE DRAWINGS

Further objects and advantages of the invention will become apparent from the following description and claims, and from the accompanying drawings, wherein:

FIG. 1 is a side plan view of the knob portion of the rotary control indicator of the present invention, visible above the control panel.

FIG. 2 is a cross-sectional view along plane 2-2 of FIG. 1.

FIG. 3 is a side cross-sectional view, partly in phantom, of the rotary control indicator of the sent invention, including the clear shaft potentiometer and LED.

FIG. 4 is a side view of the rotary control indicator of the present invention, showing the radially extending illumination.

FIG. 5 is a top view of the rotary control indicator of the present invention, showing the radially extending illumination and, by use of a phantom line, a typical extent of the peripheral illumination from the rotary control indicator.

### DETAILED DESCRIPTION OF THE PREFERRED EMBODIMENT

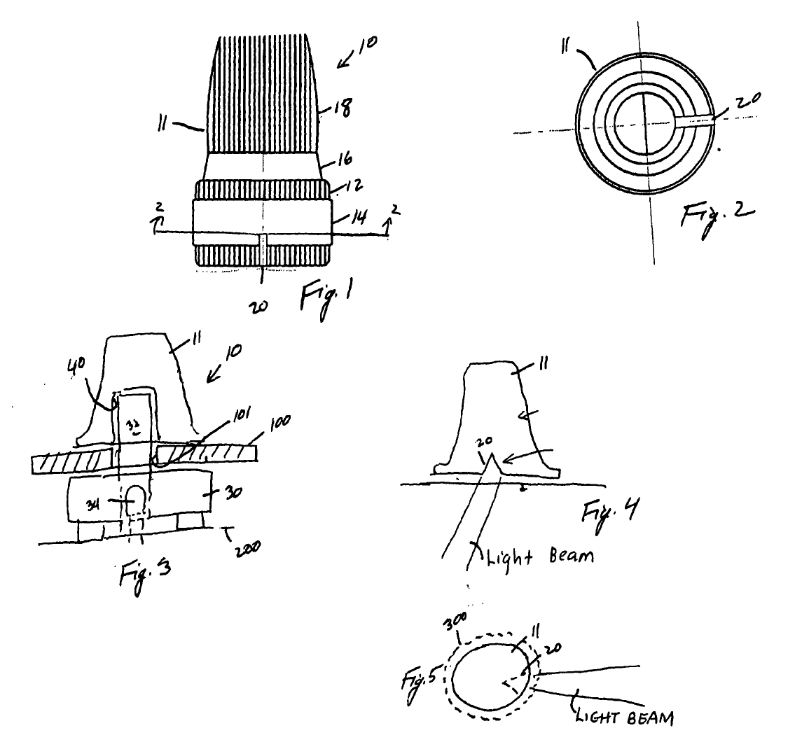

Referring now to the drawings in detail, wherein like numerals indicate like elements throughout the several views, one sees that FIG. 1 is a side plan view of the knob portion 11 of rotary control indicator 10 of the present invention, visible above the control panel. While a wide range of profiles may be used for the knob portion 11, the illustrated knob portion 11 includes a cylindrical ribbed base 12 with a central band 14. A truncated portion of a cone 16 extends from base 12 to ribbed gripping area 18. Notch 20 is radially formed on a lower portion of central band 14 and the portion of cylindrical ribbed base 12 below central band 14. FIG. 2 is a cross-sectional view showing the depth of notch 20.

FIG. 3 is a side cross-sectional view, partly in phantom, of the rotary control indicator 10. Potentiometer 30 is mounted on printed circuit board 200 and includes clear shaft 32 which extends through aperture 101 of control panel 100 and is connected to knob portion 11. The rotation of clear shaft 32 varies the resistance of potentiometer 30 thereby serving to vary the desired audio characteristic, such as volume or frequency response. Clear shaft 32 provides an axis of rotation for knob portion 11 and rotates in concert with knob portion 11. LED 34, which typically has a wide angle of view, is placed under clear shaft 32 so that light from LED 34 is directed through clear shaft 32 and out the top thereof. Clear shaft 32 may have fiber optic or light pipe characteristics to direct the light from LED 34. Light from LED 34 is projected into the interior 40 of knob portion 11. Interior 40 has a reflective surface, such as is achieved with reflective paint or chrome. The light is thereby reflected downward toward control panel 100. As there is an offset, typically 0.050 inches, between the control panel 100 and the knob portion 11, this serves to illuminate the control panel 100 around the periphery of the knob portion 11. A dashed line 300 around knob portion 11 in FIG. 5 shows a typical extent of the peripheral illumination. Additionally, light is reflected radially from notch 20 as shown in FIG. 4. The light reflected radially from notch 20 illuminates a portion of the control panel 100 so as to indicate the radial knob position to the disk jockey or other user.

Thus the several aforementioned objects and advantages are most effectively attained Although preferred embodiments of the invention have been disclosed and described in detail herein, it should be understood that this invention is in no sense limited thereby and its scope is to be determined by that of the appended claims.

1. A rotary control indicator including.
a rotary knob portion for gripping by a user, said rotary knob portion including a reflective interior,
a source of light;
a shaft provides an axis of rotation for said rotary knob portion, said shaft being able to transmit light from said source of light to said reflective interior whereby light is reflected out of said reflective interior, and
said rotary knob portion further including a radially oriented notch whereby reflected light is directed out said radially oriented notch.

2. The rotary control indicator of claim 1 wherein said knob portion rotates in concert with said shaft.

3. The rotary control indicator of claim 1 wherein said source of light is an LED placed under said shaft.

4. The rotary control indicator of claim 1 wherein said shat has light pipe characteristic.

5. The rotary control indicator of claim 1 wherein said reflective interior is chrome.

6. The rotary control indicator of claim 1 wherein said reflective interior is achieved by chrome paint.

7. The rotary control indicator of claim 1 wherein said shaft is configured and arranged so that said knob portion is offset from a control panel through which said shaft extends, thereby allowing said reflected light to illuminate a portion of the control panel peripheral to said knob portion.
